(19) United States
(12) Patent Application Publication
(10) Pub. No.: US 2022/0318006 A1
(43) Pub. Date: Oct. 6, 2022

(54) SECURE DATA ENCLAVE

(71) Applicant: MASTERCARD TECHNOLOGIES CANADA ULC, Vancouver (CA)

(72) Inventors: Justine Celeste Fox, Pitt Meadows (CA); Marc Grimson, Ithaca, NY (US); John Hearty, Vancouver (CA)

(21) Appl. No.: 17/708,358

(22) Filed: Mar. 30, 2022

Related U.S. Application Data
(60) Provisional application No. 63/168,573, filed on Mar. 31, 2021.

(51) Int. Cl. G06F 8/75; G06K 9/62; G06N 20/00; G06F 21/53

(52) U.S. Cl. CPC G06F 8/75; G06K 9/6262; G06N 20/00; G06F 21/53

(57) ABSTRACT

Methods and systems for secure model development. One system includes an electronic processor configured to receive, within a data quality assurance environment, a user input from a user device and access a code artifact stored in a code artifact repository from a data development environment based on the user input. The electronic processor is also configured to access a set of data stored in a database from a data production environment based on the user input and download a copy of the set of data without changing the set of data stored in the database. The electronic processor is also configured to train, within the data quality assurance environment, a model using machine learning based on the code artifact and the copy of the set of data. The electronic processor is also configured to transmit the model to a model database.

### CROSS-REFERENCE TO RELATED APPLICATIONS

This application claims priority to U.S. Provisional Patent Application No. 63/168,573 filed Mar. 31, 2021, the entire contents of which is incorporated by reference herein.

### FIELD

Embodiments described herein relate to a secure data enclave, and more particularly, to a secure data enclave for secure model development.

### BACKGROUND

Disparate and amalgamated systems that are traditionally used by teams to build data models often result in insufficient data protection, access restrictions, and reliability.

### SUMMARY

To solve these and other problems, embodiments described herein provide methods and systems for secure model development using, for example, a secure data enclave. The secure data enclave assists with the reliable development and management of data models at a global scale. The secure data enclave provides a development environment, a quality assurance environment, and a production environment for the purpose of providing artificial intelligence and/or machine learning models. The secure data enclave may also provide secure and private access to the resulting (derived) data. The secure data enclave may use a tiered application pattern such that software solutions may leverage artificial intelligence and machine learning models through a mechanism that is global-scale, self-healing, and auto-scaling with enhanced availability.

One embodiment provides a system for secure model development. The system includes an electronic processor configured to receive, within a data quality assurance environment, a user input from a user device. The electronic processor is also configured to access a code artifact stored in a code artifact repository from a data development environment based on the user input. The electronic processor is also configured to access a set of data stored in a database from a data production environment based on the user input. The electronic processor is also configured to download a copy of the set of data without changing the set of data stored in the database. The electronic processor is also configured to train, within the data quality assurance environment, a model using machine learning based on the code artifact and the copy of the set of data. The electronic processor is also configured to transmit the model to a model database.

Another embodiment provides a method for secure model development. The method includes receiving, within a data development environment with an electronic processor, a code input from a user device. The method also includes developing, within the data development environment with the electronic processor, a code artifact based on the code input. The method also includes storing, with the electronic processor, the code artifact in a code artifact repository of the data development environment. The method also includes accessing, with a data quality assurance environment with the electronic processor, at least one code artifact stored in the code artifact repository from the data development environment. The method also includes downloading, within the data quality assurance environment with the electronic processor, a copy of data from a database of a data production environment without changing the data from the database. The method also includes training, within the data quality assurance environment with the electronic processor, a model using machine learning based on the at least one code artifact and the copy of data. The method also includes transmitting, with the electronic processor, the model to a model database for storage.

Yet another embodiment provides a non-transitory, computer-readable medium storing instructions that, when executed by an electronic processor, perform a set of functions. The set of functions includes receiving, within a data quality assurance environment, a user input from a user device. The set of functions also includes accessing, with the data quality assurance environment, a first code artifact stored in a first code artifact repository from a first data development environment based on the user input. The set of functions also includes accessing, with the data quality assurance environment, a second code artifact stored in a second code artifact repository from a second data development environment based on the user input. The set of functions also includes downloading, with the data quality assurance environment, a copy of data stored in a database from a data production environment based on the user input without changing the data stored in the database. The set of functions also includes training, within the data quality assurance environment, a model using machine learning based on the first code artifact, the second code artifact, and the data. The set of functions also includes transmitting the model to a model database for storage.

Other aspects of the embodiments described herein will become apparent by consideration of the detailed description and accompanying drawings.

### BRIEF DESCRIPTION OF THE DRAWINGS

FIG. 1 is a block diagram of a system for secure model development according to some embodiments.

FIG. 2 is a block diagram of a server of the system of FIG. 1 according to some embodiments.

FIG. 3 is a block diagram illustrating environments of a secure data enclave according to some embodiments.

FIG. 4 is a flow chart of a method for secure model development using the system of FIG. 1 according to some embodiments.

FIG. 5 is a block diagram illustrating an exemplary workflow of a data development environment according to some embodiments.

FIG. 6 is a block diagram illustrating an exemplary workflow of a data quality assurance environment according to some embodiments.

FIGS. 7-8 are block diagrams illustrating an exemplary workflow of a data production environment according to some embodiments.

FIG. 9 is a block diagram illustrating a secure connection between a data center and a data production environment according to some embodiments.

FIG. 10 is a block diagram illustrating an exemplary workflow of the secure data enclave from a user's perspective according to some embodiments.

Other aspects of the embodiments described herein will become apparent by consideration of the detailed description.

### DETAILED DESCRIPTION OF THE EMBODIMENTS

Before embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. That is, the embodiments described herein illustrate possible implementations of the invention and are not to be interpreted as a comprehensive list of implementations.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and may include electrical connections or couplings, whether direct or indirect. Also, electronic communications and notifications may be performed using any known means including direct connections, wireless connections, etc.

A plurality of hardware and software based devices, as well as a plurality of different structural components may be utilized to implement the embodiments described herein. In addition, embodiments described herein may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects of the embodiments described herein may be implemented in software (for example, stored on non-transitory computer-readable medium) executable by one or more processors. For example, “computing device,” and “server” as described in the specification may include one or more electronic processors, one or more memory modules including non-transitory computer-readable medium, one or more input/output interfaces, and various connections (for example, a system bus) connecting the components.

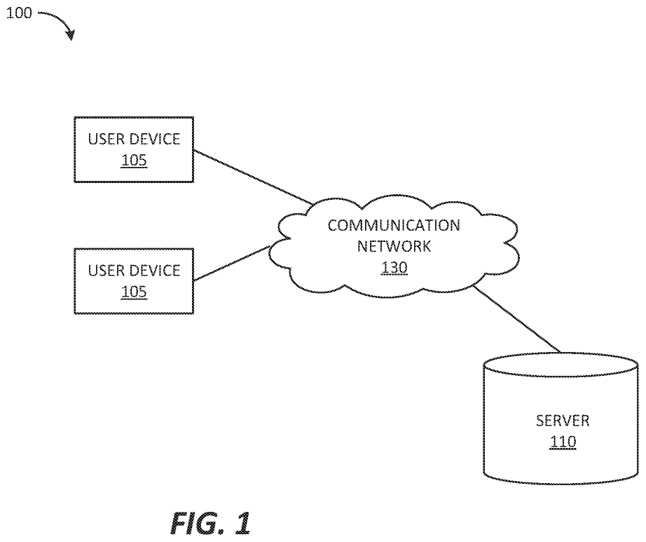

FIG. 1 is a block diagram of a system 100 for secure model development according to some embodiments. In the example shown, the system 100 includes a plurality of user devices 105 (referred to herein collectively as “the user devices 105” and individually as “the user device 105”) and a server 110. In some embodiments, the system 100 includes fewer, additional, or different components than illustrated in FIG. 1. For example, the system 100 may include multiple servers 110. Alternatively or in addition, the system 100 may include a different number of user devices and the two user devices 105 included in FIG. 1 are purely for illustrative purposes.

In the embodiment shown, the server 110 and the user devices 105 are communicatively coupled via a communication network 130. The communication network 130 is an electronic communications network including wireless and wired connections. Portions of the communication network 130 may be implemented using a wide area network, such as the Internet, a local area network, such as a Bluetooth™ network or Wi-Fi, and combinations or derivatives thereof. Alternatively or in addition, in some embodiments, components of the system 100 communicate directly with each other as compared to communicating through the communication network 130. Also, in some embodiments, the components of the system 100 communicate through one or more intermediary devices not illustrated in FIG. 1.

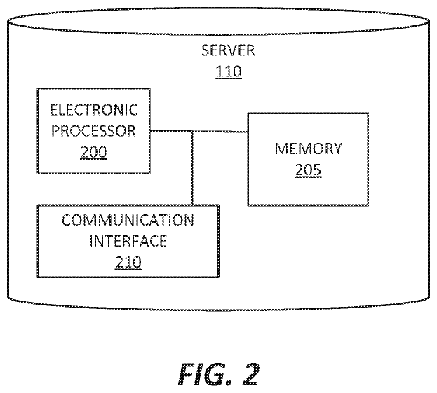

The server 110 may be a computing device, which may provide or function as a secure data enclave for securely developing models, such as artificial intelligence models or machine learning models. In the embodiment shown in FIG. 2, the server 110 includes an electronic processor 200, a memory 205, and a communication interface 210. The electronic processor 200, the memory 205, and the communication interface 210 communicate wirelessly, over one or more communication lines or buses, or a combination thereof. The server 110 may include additional components than those illustrated in FIG. 2 in various configurations. The server 110 may also perform additional functionality other than the functionality described herein. Also, the functionality (or a portion thereof) described herein as being performed by the server 110 may be distributed among multiple servers or devices, such as multiple servers included in a cloud service environment. For example, in some embodiments, the server 110 is part of a computing network, such as a distributed computing network, a cloud computing service, or the like. In addition, in some embodiments, one or more of the user devices 105 may be configured to perform all or a portion of the functionality described herein as being performed by the server 110.

The electronic processor 200 may include a microprocessor, an application-specific integrated circuit (ASIC), or another suitable electronic device for processing data. The memory 205 may include a non-transitory computer-readable medium, such as read-only memory (“ROM”), random access memory (“RAM”) (for example, dynamic RAM (“DRAM”), synchronous DRAM (“SDRAM”), and the like), electrically erasable programmable read-only memory (“EEPROM”), flash memory, a hard disk, a secure digital (“SD”) card, another suitable memory device, or a combination thereof. The electronic processor 200 is configured to access and execute computer-readable instructions (“software”) stored in the memory 205. The software may include firmware, one or more applications, program data, filters, rules, one or more program modules, and other executable instructions. For example, the software may include instructions and associated data for performing a set of functions, including the methods described herein.

In the embodiment shown, the communication interface 210 allows the server 110 to communicate with devices external to the server 110. For example, as illustrated in FIG. 1, the server 110 may communicate with one or more of the user devices 105 through the communication interface 210. In particular, the communication interface 210 may include a port for receiving a wired connection to an external device (for example, a universal serial bus (“USB”) cable and the like), a transceiver for establishing a wireless connection to an external device (for example, over one or more communication networks 130, such as the Internet, local area network (“LAN”), a wide area network (“WAN”), and the like), or a combination thereof.

The user device 105 may also be a computing device and may include a desktop computer, a terminal, a workstation, a laptop computer, a tablet computer, a smart watch or other wearable, a smart television or whiteboard, or the like. Although not illustrated, the user device 105 may include similar components as the server 110 (an electronic processor, a memory, and a communication interface). The user device 105 may also include a human-machine interface. The human-machine interface may include one or more input devices, one or more output devices, or a combination thereof. Accordingly, in some embodiments, the human-machine interface allows a user to interact with (for example, provide input to and receive output from) the user device 105. For example, the human-machine interface may include a keyboard, a cursor-control device (for example, a mouse), a touch screen, a scroll ball, a mechanical button, a display device (for example, a liquid crystal display (“LCD”)), a printer, a speaker, a microphone, or a combination thereof.

A user (for example, a data scientist, a data analyst, a data engineer, and the like) may use the user device 105 to develop an artificial intelligence model, a machine learning model, another type of model, or a combination thereof. For example, a user may access the secure data enclave (through a browser application or a dedicated application stored on the user device 105 that communicates with the server 110) and interact with the secure data enclave (i.e., one or more environments provided by the secure data enclave) via the human-machine interface associated with the user device 105. In some embodiments, a user may use the user device 105 to interact with the secure data enclave (for example, a data development environment provided by the secure data enclave) to write code for artificial intelligence and/or machine learning activities, publish a code artifact for use in training a machine learning model, and the like. Alternatively or in addition, in some embodiments, a user may use the user device 105 to interact with the secure data enclave (for example, a data quality assurance environment provided by the secure data enclave) to leverage one or more published code artifacts for exploration, model development, and the like. Alternatively or in addition, in some embodiments, a user may use the user device 105 to interact with the secure data enclave (for example, a data quality assurance environment provided by the secure data enclave) to export or transmit a developed model.

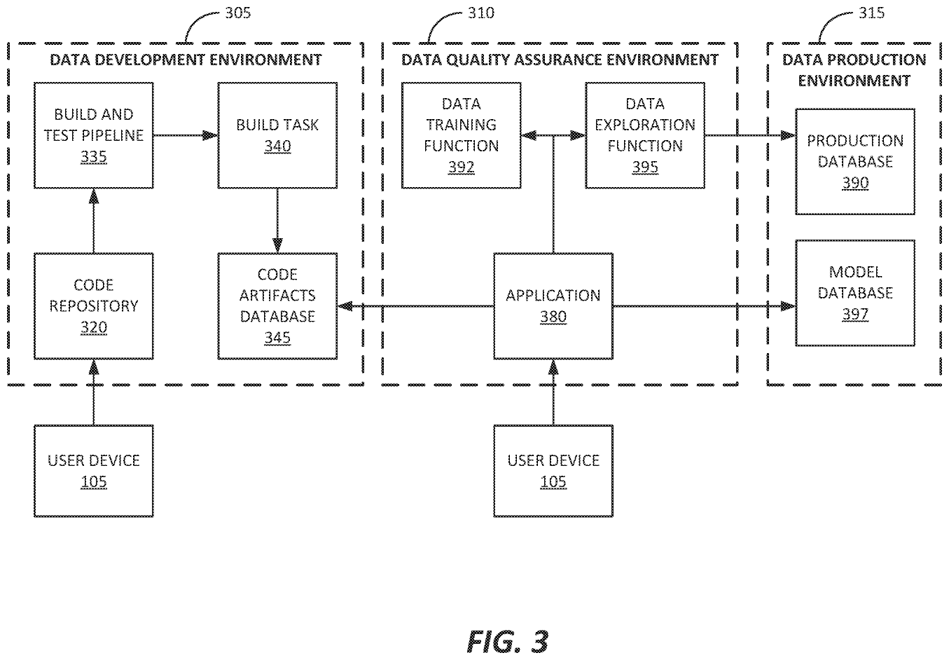

In some embodiments, the secure data enclave provides (or includes) multiple environments. Each environment may include controls designed for high velocity data development teams while preserving the security of (derived) customer data. For example, FIG. 3 is a block diagram illustrating the environments of the secure data enclave according to some embodiments. In the illustrated example, the secure data enclave includes three environments. As seen in FIG. 3, the secure data enclave includes a data development environment 305, a data quality assurance environment 310, and a data production environment 315.

In some embodiments, the secure data enclave may include additional, fewer, or different environments than illustrated in FIG. 3 in various configurations. For example, in some embodiments, the secure data enclave provides multiple data development environments 305. For example, the secure data enclave may provide multiple data development environments 305 for each developer or team, distributed for isolation, with code artifacts being published to an approved data store (for example, a corresponding code artifact repository).

As noted above, in some embodiments, the functionality (or a portion thereof) of the server 110 may be distributed among multiple devices or servers. Accordingly, in some embodiments, the system 100 includes multiple servers 110, where each server 110 provides an environment described herein as being provided by the server 110. For example, the data development environment 305 may be provided by a first server (for example, a data development server), the data quality assurance environment 310 may be provided by a second server (for example, a data quality assurance server), and the data production environment 315 may be provided by a third server (for example, a data production server). In such embodiments, multiple servers may communicate directly with each other over one or more wired communication lines or buses. Additionally, in some embodiments, the data development environment 305, the data quality assurance environment 310, the data production environment 315, or a combination thereof may include additional, fewer, or different components than illustrated in FIG. 3 in various configurations.

The data development environment 305 is an environment where a user, such as a data scientist or a data engineer, may write code and develop new machine learning or artificial intelligence solutions (i.e., models) programmatically without exposing real customer data. In other words, in some embodiments, the data development environment 305 does not have access to customer data (for example, production product data). Rather, the data development environment 305 enables (via the electronic processor 200) a user to write code for artificial intelligence and/or machine learning activities. Accordingly, the data development environment 305 is an environment for developing libraries and frameworks using application programming languages, such as python or java.

In the embodiment shown in FIG. 3, the data development environment 305 includes a code repository 320 that interfaces with the user device 105. In response to the user device 105 interfacing with the code repository 320, a build system or processor of the data development environment 305 is triggered. The build system or process of the data development environment 305 may include a build and test pipeline 335 and a build task 340. In the embodiment shown in FIG. 3, the data development environment 305 also includes a code artifact repository 345. The code artifact repository 345 stores one or more code artifacts resulting from the build system or process of the data development environment 305 (for example, the build and test pipeline 335, the build task 340, or a combination thereof).

The data quality assurance environment 310 may be an environment for data exploration and model development. In some embodiments, the data quality assurance environment 310 is a controlled environment that does not have Internet access. As seen in FIG. 3, the data quality assurance environment 310 includes an application 380 that interfaces with the user device 105. The application 380 may be an open-source web application, such as a jupyter notebook, configured to allow a user to create and share documents that contain live code, equations, visualizations, narrative text, and the like. As seen in FIG. 3, the application 380 (via the electronic processor 200) may access the code artifact repository 345 of the data development environment 305. The application 380 may access the code artifact repository 345 to leverage one or more code artifacts published to the code artifact repository 345. In some embodiments, the application 380 (i.e., the data quality assurance environment 310) has read-only access to the code artifact repository 345. In some embodiments, the electronic processor 200 (via, for example, the application 380) implements an access control list to enable read-only access to the code artifacts of the code artifact repository 345.

In the embodiment shown in FIG. 3, the data quality assurance environment 310 also communicates (or interfaces) with the data production environment 315. The data quality assurance environment 310 may communicate with the data production environment 315 to access data (i.e., a set of data) from a production database 390 of the data production environment 315, as seen in FIG. 3. The data stored in the production database 390 may include, for example, production data, customer data, and the like. In some embodiments, the data quality assurance environment 310 has read-only access to the production database 390. In some embodiments, the data quality assurance environment 310 accesses (or downloads a copy of) data from the production database 390 for data exploration, model development, or a combination thereof. In other words, in some embodiments, the data quality assurance environment 310 provides a no Internet access safe environment where data (i.e., the downloaded or accessed copy of data) may be freely manipulated and transformed without impacting (or changing) an original state (i.e., an original copy or version) of the data stored in the production database 390. In some embodiments, the electronic processor 200 performs the data exploration, the model development, or a combination thereof using a data training function 392, a data exploration function 395, or a combination thereof. When a model is trained or developed (via, for example, the data training function 392, the data exploration function 395, or a combination thereof), the model may be transmitted (or exported) to a model database 397. As illustrated in FIG. 3, the model database 397 may be included in the data production environment 315. Accordingly, in such embodiments, the model is exported to and used by a product or solution supported or provided by the data production environment 315. Alternatively or in addition, in some embodiments, the model database 397 is included within the data quality assurance environment 310. In such embodiments, the data quality assurance environment 310 may host the model database 397 (as a hosted model database) for access and utilization by a product or solution environment (for example, the data production environment 315).

As illustrated in FIG. 3, the data production environment 315 may include the production database 390 and the model database 397. In some embodiments, the data production environment 315 is not directly accessible by user. In such embodiments, the data production environment 315 may be a development environment, a quality assurance environment, a production environment, or a combination thereof for an application programming interface (API) solution. For example, the data production environment 315 may be an isolated environment that enables data-powered applications for an application development team or user. In other embodiments, the data production environment 315 hosts the model database 397 (as a hosted model database) for private access, public access, or a combination thereof. For example, in such embodiments, the data production environment 315 is a hosted environment that enables end-to-end model management for one or more users. Accordingly, in some embodiments, the data production environment 315 provides a model hosting service.

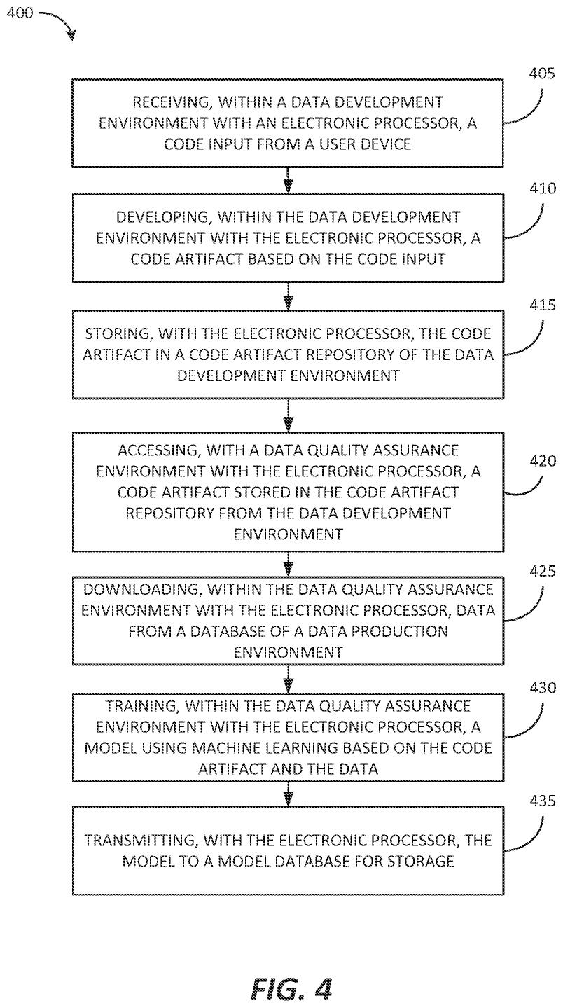

FIG. 4 is a flowchart illustrating a method 400 for secure model development using the system 100 of FIG. 1 according to some embodiments. The method 400 is described here as being performed by the server 110 (the electronic processor 200 executing instructions). However, as noted above, the functionality performed by the server 110 (or a portion thereof) may be performed by other devices or servers, including, for example, one or more of the user devices 105 (via an electronic processor executing instructions), one or more servers (via an electronic processor executing instructions), or a combination thereof. For example, the functionality associated with the data development environment 305 may be performed by an electronic processor of a data development server, the functionality associated with the data quality assurance environment 310 may be performed by an electronic processor of a data quality assurance server, and the functionality associated with the data production environment 315 may be performed by an electronic processor of a data production server.

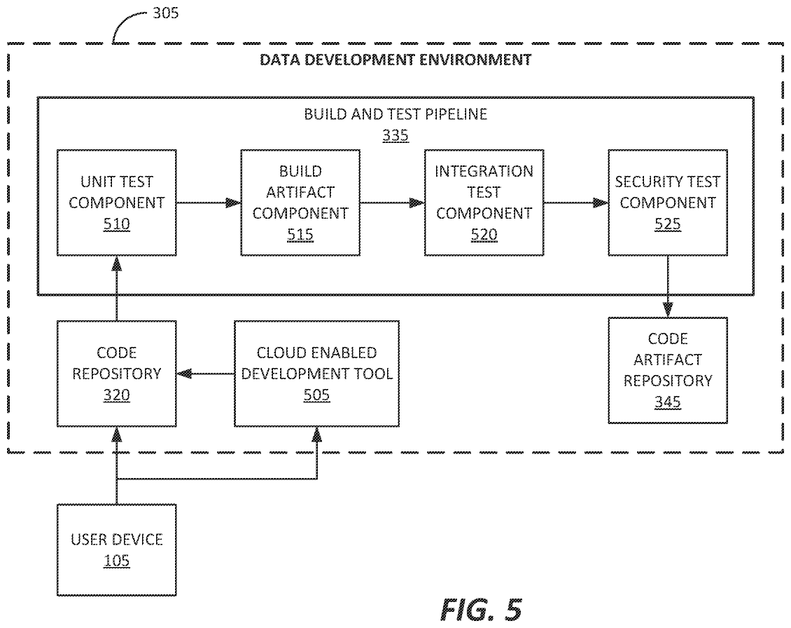

As illustrated in FIG. 4, the method 400 includes receiving, within the data development environment 305 with the electronic processor 200, a code input from the user device 105 (at block 405). In some embodiments, the electronic processor 200 receives the code input (i.e., written code) from the user device 105 at the code repository 320. As noted above with respect to FIG. 3, the code repository 320 interfaces with the user device 105. In some embodiments, the code repository 320 is a git repository. In such embodiments, the data development environment 305 may host a git repository (i.e., the code repository 320) as an interface for performing development from a local workstation (for example, the user device 105). As seen in FIG. 5, in some embodiments, the user device 105 may interface directly with the code repository 320. However, in other embodiments, the user device 105 may interface indirectly with the code repository 320 through an intermediary device, service, tool, environment, or the like. For example, as illustrated in FIG. 5, the user device 105 may interface indirectly with the code repository 320 through a cloud enabled development tool 505.

After receiving the code input from the user device 105 (at block 405), the electronic processor 200, within the data development environment 305, develops a code artifact based on the code input (at block 410). As noted above, the data development environment 305 (via the electronic processor 200) may use the written code (i.e., the code input) to develop a new machine learning or artificial intelligence solution. Accordingly, in response to the user device 105 interfacing with the code repository 320, a build system or process (for example, the build and test pipeline 335) of the data development environment 305 is triggered. In some embodiments, the build and test pipeline 335 of the data development environment 305 verifies that the code meets established guidelines. For example, a user may use one or more code review processes (executed by the electronic processor 200) when writing code within the data development environment 305. A code review process may include, for example, a code security scan, a code vulnerability scan, and the like. The code review process may be included as part of the build and test pipeline 335, the build task 340, or a combination thereof. Accordingly, as seen in FIG. 5, the build and test pipeline 335 may include, for example, a unit test component 510, a build artifact component 515, an integration test component 520, and a security test component 525. In some embodiments, the build and test pipeline 335 of the data development environment 305 includes additional, fewer, or different components than illustrated in FIG. 5 in various configurations. For example, in some embodiments, the build and test pipeline 335 includes additional or different testing processes than illustrated in FIG. 5.

In the embodiment shown, the electronic processor 200 stores (or publishes) the code artifact in the code artifact repository 345 of the data development environment 305 (at block 415). As noted above, a code artifact of the data development environment 305 may be published (or stored) to the code artifact repository 345. In some embodiments, the code artifact repository 345 accepts code artifacts directly from a user (via the user device 105). Alternatively or in addition, in some embodiments, the code artifact repository 345 does not accept code artifacts directly from a user (via the user device 105). In such embodiments, the code artifact repository 345 only accepts verified code artifacts from the build system or process (for example, the build and test pipeline 335).

As noted above, a user (via the user device 105) may interface with the data quality assurance environment 310 through the application 380. Accordingly, in some embodiments, the electronic processor 200 receives, within the data quality assurance environment 310, a user input from the user device 105 through the application 380. The user input may be associated with a data exploration function, a model development function, or a combination thereof. In other words, the electronic processor 200 may use the user input to perform a data exploration function, a model development function, or a combination thereof, such as developing a model.

In the embodiment shown in FIG. 4, the method 400 also includes accessing, within the data quality assurance environment 310 with the electronic processor 200, a code artifact stored in the code artifact repository 345 from the data development environment 305 (at block 420). The electronic processor 200 may also download, within the data quality assurance environment 310, data from a database (e.g., the production database 390) of the data production environment 315 (at block 425). In some embodiments, the electronic processor 200 accesses the code artifact, downloads the data, or a combination thereof in response to receiving a user input from the user device 105 with the application 380. As noted above, in some embodiments, the electronic processor 200 enables read-only access between the data quality assurance environment 310 and the code artifact repository 345, the production database 390, or a combination thereof. For example, in response to receiving the user input from the user device 105, the electronic processor 200 may access the code artifact from the code artifact repository 345 via read-only access.

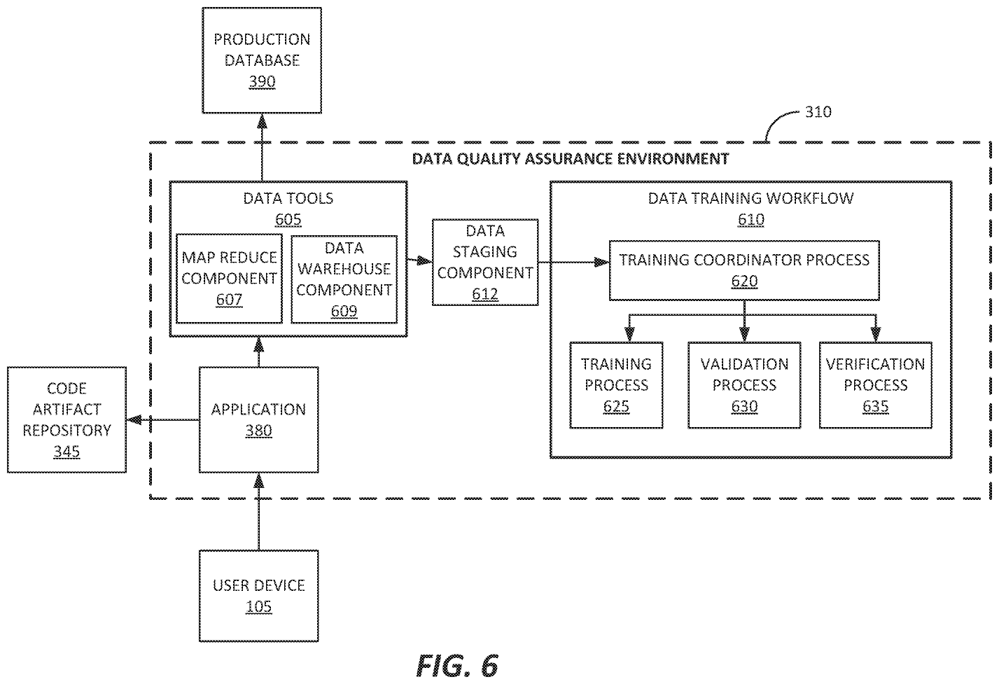

In some embodiments, the electronic processor 200 implements one or more data tools 605 as part of the data quality assurance environment 310, as seen in FIG. 6. In the illustrated example of FIG. 6, the data tools 605 may include a map reduce component 607 and a data warehouse component 609. However, in some embodiments, the electronic processor 200 implements additional, fewer, or different data tools than illustrated in FIG. 6. The electronic processor 200 may implement the data tools 605 as part of the data exploration function 395. In some embodiments, the electronic processor 200 enables a user (via the application 380) to work with the data from the production database 390 using, for example, one or more of the data tools 605.

In some embodiments, the electronic processor 200 trains (or develops), within the data quality assurance environment 310, a model using machine learning based on the code artifact and the data (at block 430). In other words, the electronic processor 200 trains the model using one or more machine learning functions based on the code artifact and the data. Machine learning functions are generally functions that allow a computer application to learn without being explicitly programmed. Machine learning performed by the electronic processor 200 may be performed using various types of methods and mechanisms including but not limited to decision tree learning, association rule learning, artificial neural networks, inductive logic programming, support vector machines, clustering, Bayesian networks, reinforcement learning, representation learning, similarity and metric learning, sparse dictionary learning, and genetic algorithms. These approaches allow the electronic processor 200 to ingest, parse, and understand data and progressively refine models for data analytics.

In some embodiments, the electronic processor 200 performs a data training workflow 610, as illustrated in FIG. 6. In some embodiments, the electronic processor 200 may export the data to a local event store for data orchestration and training. In some embodiments, the electronic processor 200 exports the data from the production database 390, the code artifact from the code artifact repository 345, or a combination thereof to a data staging component 612. As part of the data training workflow 610, the electronic processor implements a training coordinator process 620 that manages a training process 625, a validation process 630, and a verification process 635. In some embodiments, the training coordinator process 620 (via the electronic processor 200) adjusts training based on available training type and desired training activity. The electronic processor 200 may implement the training coordinator process 620 as part of the data training function 392.

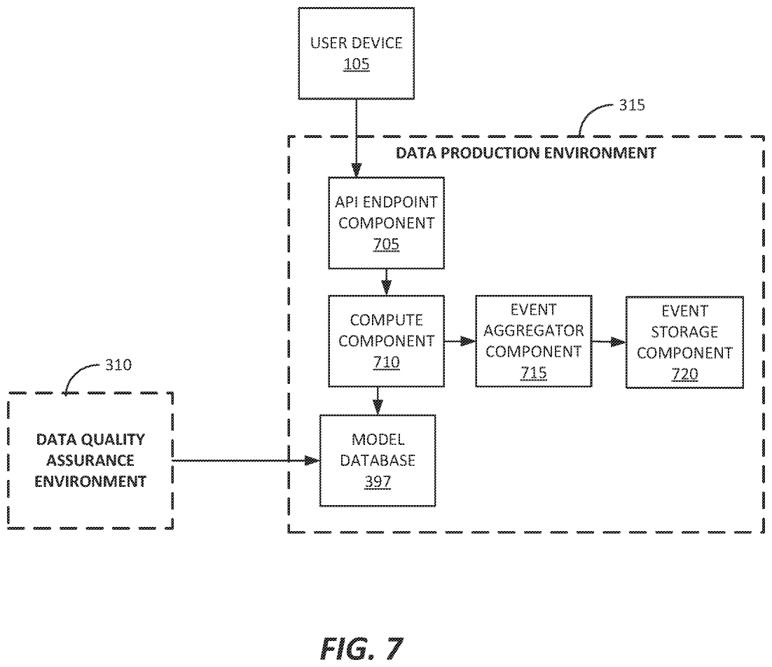

In the embodiment shown, after a model is trained, the electronic processor 200 transmits (or exports) the model to the model database 397 for storage (at block 435). As noted above, in some embodiments, the data production environment 315 is not directly accessible by a user. For example, the data production environment 315 may be an isolated environment that enables data-powered applications for an application development team or user. In such embodiments, the data production environment 315 may be a development environment, a quality assurance environment, a production environment, or a combination thereof for an application programming interface (API) solution, as illustrated in FIG. 7. As seen in FIG. 7, the data production environment 315 (via the electronic processor 200) may provide an API solution that includes the model database 397, as an exported model database where the models stored in the model database 397 may be whitelisted for the product environment. In such embodiments, the data production environment 315 may also include one or more components associated with the API solution, such as an API endpoint component 705 that interfaces with the user device 105, a compute component 710, an event aggregator component 715, and an event storage component 720. Accordingly, as illustrated in FIG. 7, the electronic processor 200 may export (or transmit) the model (i.e., the trained model) from the data quality assurance environment to the data production environment 315 for storage within the model database 397, where the model may be used within the API solution provided by the data production environment 315.

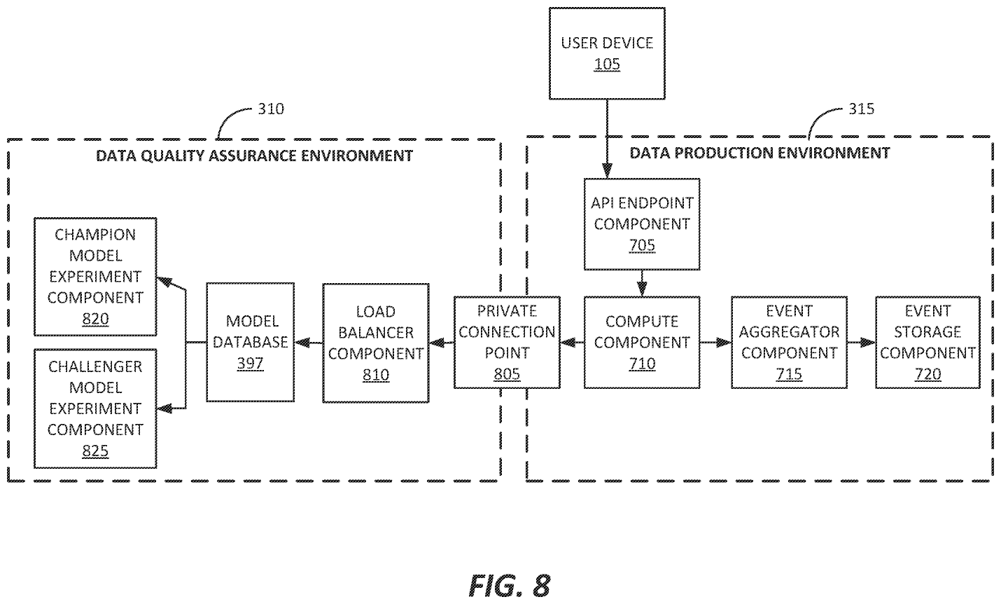

Alternatively or in addition, in some embodiments, the data quality assurance environment 310 hosts the model database 397 (as a hosted model database), as illustrated in FIG. 8. For example, as seen in FIG. 8, the data production environment 315 may provide an API solution (with similar components as illustrated in FIG. 7). However, in such embodiments, the model database 397 is hosted by the data quality assurance environment 310. Accordingly, the data production environment 315 may interface with the data quality assurance environment 310 through, for example, a private connection point 805. In some embodiments, the data production environment 315 includes a load balancer component 810.

In some embodiments, the secure data enclave includes (or has access to) multiple data production environments 315. In such embodiments, the electronic processor 200 may generate, train, and develop new models and test the new models in one or more champion versus challenger experiments (represented in FIG. 8 as a champion model experiment component 820 and a challenger model experiment component 825).

Accordingly, in such embodiments, the data quality assurance environment 310 (via the electronic processor 200) may host machine learning or artificial intelligence models and provide the models through a private connection (for example, the private connection point 805) to product or solution environments (for example, the data production environment 315). The product or solution environments may consume the hosted models through a secure application programming interface.

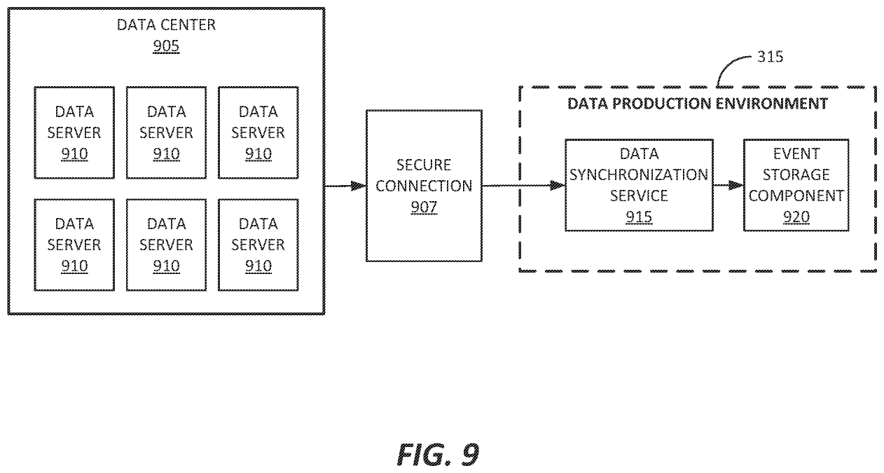

Alternatively or in addition, as seen in FIG. 9, the data production environment 315 may communicate (or interface) with to a data center 905, such as a corporate data center. The data production environment 315 and the data center 905 may communicate (or interface) through a secure connection 907, such as a secure virtual private network connection. As seen in FIG. 9, the data center 905 may include a plurality of data servers 910 and the data production environment 315 may provide a data synchronization service 915. In such embodiments, the data production environment 315 (via the electronic processor 200) exposes event data (from an event storage component 920) through an interface to the secure data enclave.

In some embodiments, as noted above, the secure data enclave includes multiple data development environments 305. In such embodiments, the electronic processor 200 may be configured to receive multiple code artifacts from multiple data development environments 305. For example, the electronic processor 200 may access a first code artifact stored in a first code artifact repository from a first data development environment and access a second code artifact stored in a second code artifact repository from a second data development environment based on the user input. In response to accessing the first code artifact and the second code artifact, the electronic processor 200 may train the model (within the data quality assurance environment 310) using machine learning based on the first code artifact, the second code artifact, and the data from the production database 390.

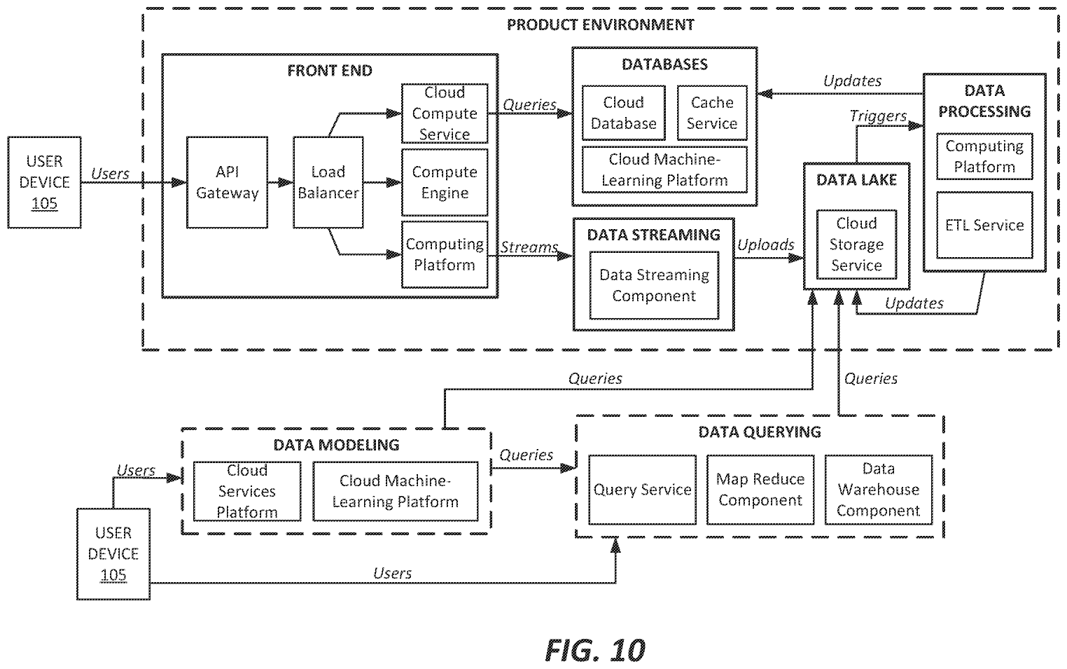

Thus, the embodiments described herein provide, among other things, methods and systems for secure model development using, for example, a secure data enclave. FIG. 10 illustrates an exemplary workflow of how the secure data enclave may be used to query a product's production environment from a user's perspective (for example, a data scientist). Various features and advantages of the invention are set forth in the following claims.

What is claimed is:

1. A system for secure model development, the system comprising:
an electronic processor configured to
receive, within a data quality assurance environment, a user input from a user device,
access a code artifact stored in a code artifact repository from a data development environment based on the user input,
access a set of data stored in a database from a data production environment based on the user input to download a copy of the set of data without changing the set of data stored in the database,
train, within the data quality assurance environment, a model using machine learning based on the code artifact and the copy of the set of data, and transmit the model to a model database.

2. The system of claim 1, wherein the code artifact is associated with a machine learning function.

3. The system of claim 1, wherein the code artifact is developed within the data development environment using a review process that includes at least one selected from a group consisting of a code security scan and a code vulnerability scan.

4. The system of claim 1, wherein the data quality assurance environment has read-only access to the code artifact repository.

5. The system of claim 1, wherein the data quality assurance environment has read-only access to the database.

6. The system of claim 1, wherein the data quality assurance environment is not connected to an external communications network.

7. The system of claim 1, wherein the model database is hosted within the data quality assurance environment.

8. The system of claim 1, wherein the data production environment is an isolated environment for an application programming interface solution.

9. The system of claim 1, wherein the code artifact is developed within the data development environment in response to a code input.

10. The system of claim 1, wherein the electronic processor is configured to train the model by implementing a training coordinator process that manages a training process, a validation process, and a verification process.

11. The system of claim 1, wherein the model database is within the data production environment.

12. The system of claim 1, wherein the electronic processor is further configured to receive, within the data development environment, a code input;
develop, within the data development environment, the code artifact based on the code input; and
store the code artifact within the code artifact repository of the data development environment.

13. A method for secure model development, the method comprising:
receiving, within a data development environment with an electronic processor, a code input from a user device;
developing, within the data development environment with the electronic processor, a code artifact based on the code input;
storing, with the electronic processor, the code artifact in a code artifact repository of the data development environment;
accessing with a data quality assurance environment with the electronic processor, at least one code artifact stored in the code artifact repository from the data development environment;
downloading, within the data quality assurance environment with the electronic processor, a copy of data from a database of a data production environment without changing the data from the database;
training, within the data quality assurance environment with the electronic processor, a model using machine learning based on the at least one code artifact and the copy of data; and,
transmitting, with the electronic processor, the model to a model database for storage.

14. The method of claim 13, further comprising:
providing the data quality assurance environment with read-only access to the code artifact repository and the database.

15. The method of claim 13, wherein transmitting the model to the model database includes exporting the model to an isolated environment for an application programming interface solution.

16. The method of claim 13, wherein transmitting the model to the model database includes storing the model in a hosted model database of the data quality assurance environment.

17. A non-transitory, computer-readable medium storing instructions that, when executed by an electronic processor, perform a set of functions, the set of functions comprising:
receiving, within a data quality assurance environment, a user input from a user device;
accessing, with the data quality assurance environment, a first code artifact stored in a first code artifact repository from a first data development environment based on the user input;
accessing, with the data quality assurance environment, a second code artifact stored in a second code artifact repository from a second data development environment based on the user input;
downloading, with the data quality assurance environment, a copy of data stored in a database from a data production environment based on the user input without changing the data stored in the database;
training, within the data quality assurance environment, a model using machine learning based on the first code artifact, the second code artifact, and the data; and
transmitting the model to a model database for storage.

18. The computer-readable medium of claim 17, wherein transmitting the model to the model database includes exporting the model to an isolated environment for an application programming interface solution.

19. The computer-readable medium of claim 17, wherein transmitting the model to the model database includes storing the model in a hosted model database.

20. The computer-readable medium of claim 17, wherein accessing the first code artifact from the first data development environment and accessing the second code artifact from the second data development environment includes accessing the first code artifact and the second code artifact from different data development environments.
